(19) United States
(12) Patent Application Publication
(10) Pub. No.: US 2003/0028485 A1
(43) Pub. Date: Feb. 6, 2003

(54) System and method for providing convenient global access to and storage of personal and business information

(76) Inventor: Bernando A. Huberman, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/918,762

(22) Filed: Jul. 30, 2001

Related U.S. Application Data
(60) Provisional application No. 60/301,543, filed on Jun. 27, 2001.

(51) Int. Cl. G06F 17/60; H04M 11/00

(52) U.S. Cl. 705/43; 379/93.01; 705/1

(57) ABSTRACT

A system and method for data transaction is disclosed. The method of the present invention includes the steps of: receiving an ATM card or a telephone call from a user; providing secure access to a data file containing data items previously input by the user; selecting a data item, in response to a command from the user; and outputting the selected data item to the user. Within the system of the present invention: a data network interface, receives an Automated Teller Machine (ATM) card from a user, or a telephone call from a user; an identity authentication module authenticates the ATM card or the telephone call, and the user; a transaction management module provides secure access to a data file containing data items previously input by the user; and a data file repository stores the data file.

### REFERENCE TO PROVISIONAL APPLICATION TO CLAIM PRIORITY

A priority date for this present U.S. patent application has been established by prior U.S. Provisional Patent Application, Serial No. 06/301543 entitled “System And Method For Global Access To Personal And Business Information Using A Data Network,” filed on Jun. 27, 2001 by inventor Bernardo A. Huberman.

### BACKGROUND OF THE INVENTION

1. Field of the Invention

The present invention relates generally to systems and methods for managing personal and business information, and more particularly for providing convenient global access to and storage of personal and business information.

2. Discussion of Background Art

Important and often confidential documents, certificates, photos, drawings, and other information, used in day-to-day personal, business and government contexts, are often either kept in paper form in various secure and/or un-secure environments, distributed throughout and buried within many different disconnected databases, and/or stored in laptops or Personal Data Assistants (PDAs) which users forgot to bring with them. Such information may include: contracts, property titles, passports, family photos, customer contact lists, architectural drawings, prescription and medical information, account numbers, or any sort of personal or business related information.

Traveling sales representative, individuals on vacation, government employees, and others however often have need of such information on short notice, such as in response to a customer request, to close a business deal, or to provide health data in response to a medical emergency.

Currently, individuals in need of such information must resort to: calling the home office and requesting that a co-worker locate and retrieve the required information; asking a friend or family member to “stop by the bank” and go through the individual's safe deposit box in order to retrieve the necessary information such as a deed or a passport; and/or scrambling to find a hotel with a data-port somewhere to which a bulky cable and computer must be connected.

Such conventional methods of obtaining important information are very time consuming and awkward. Even further, the accuracy of the information obtained by such methods can be of questionable accuracy. For example, a person responding to a call for information may photocopy and/or fax the information to the requester; however, often the simple process of photocopying and faxing blurs and renders illegible the important information requested. Even a coworker may misread important data spoken over the phone. Similar limitation are incurred when individuals attempt to record and/or store important information for later use.

Current data storage and retrieval services, offered by various large organizations, are often limited to the storage and display of only specific types of data, such as bank statements, stock holdings, and advertisements, which vary in their level of trust and reliability.

In response to the concerns discussed above, what is needed is a system and method for providing convenient global access to and storage of personal and business information that overcomes the problems of the prior art.

### SUMMARY OF THE INVENTION

The present invention is a system and method for data transaction. The method of the present invention includes the steps of: receiving an Automated Teller Machine (ATM) card from a user at an ATM, or receiving a telephone call from a user on a telephone network; providing secure access to a data file containing data items previously input by the user; selecting a data item from the data file, in response to a command from the user; and outputting the selected data item to the user from the ATM, or over the telephone network.

Within the system of the present invention: a data network interface, receives an Automated Teller Machine (ATM) card from a user, or a telephone call from a user; an identity authentication module authenticates the ATM card or the telephone call, and the user; a transaction management module provides secure access to a data file containing data items previously input by the user; and a data file repository stores the data file.

The system and method of the present invention are particularly advantageous over the prior art for at least the following reasons: existing ATM and telephone network infrastructure is used; the present invention provides instantaneous data access on a global basis from trusted sources; the present invention is convenient, requiring in some embodiments, no more than an ATM card, or telephone number; and ATM machines already have an ability to accept, display, and print information.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of a system for providing global access to and storage of personal and business information; and

FIG. 2 is a flowchart of a method for providing global access to and storage of personal and business information.

### DETAILED DESCRIPTION OF THE PREFERRED EMBODIMENT

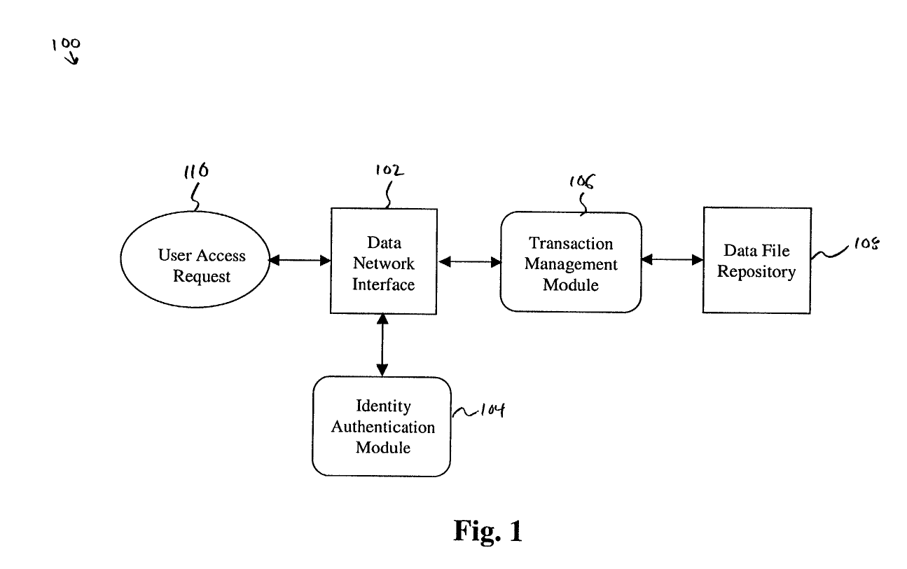

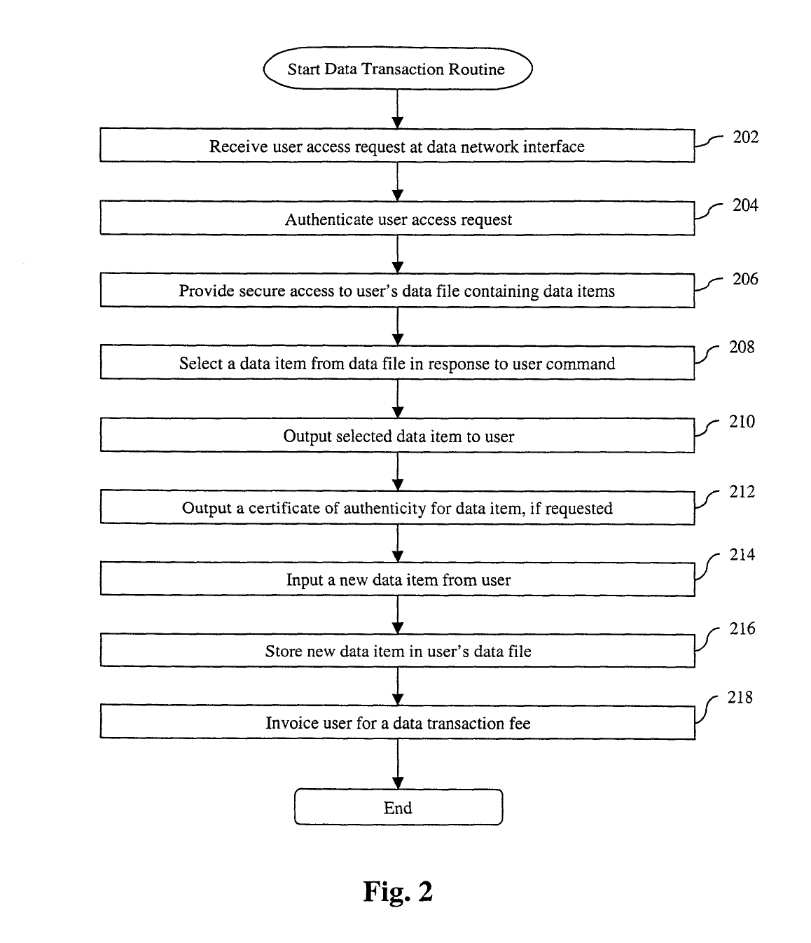

FIG. 1 is a dataflow diagram of a system 100 for providing global access to personal and business information. The system 100 includes a data network interface 102, an identity authentication module 104, a transaction management module 106, and a data file repository 108. FIG. 2 is a flowchart of a method 200 for providing global access to and storage of personal and business information. FIGS. 1 and 2 are now discussed together.

The method 200 begins in step 202 where the data network interface 102 receives a user access request 110. The data network interface 102 is preferably a device which is in pervasive use throughout a geographical area and/or most of the world. Such devices include Automated Teller Machines (ATMs), telephones, wireless devices, service station fueling pumps, and others. The fueling pumps may include, gas pumps, and electric outlets at public service stations. If the data network interface 102 takes the form of an ATM, the user access request 110 is generated in response to a user inserting an ATM card into the ATM machine. If, however, the data network interface 102 takes the form of a telephone, the user access request 110 is generated in response to a user dialing a telephone number. Thus the system and method of the present invention may be provided to users by any large institution providing a data network. Such institutions may include banks, brokerages, and telephone service providers.

In either case, next in step 204, the user access request is authenticated by the identity authentication module 104, which is coupled to the data network interface 100. Authentication typically may occur through use of a password, but other methods, such as biometric scanning, including voice authentication, may authenticate the user. In step 206, the transaction management module 106, which couples the data network interface 100 to the data file repository 108, provides secure access to the user's data file within the data file repository 108. The user's data file contains a plurality of data items, such as important documents, deeds, photos, drawing, important numbers, as well as others and can be thought of as a digital analog of a bank safe deposit box.

In step 208, the transaction management module 106 selects a data item from user's data file in response to a user command entered into the data network interface 102. In step 210, the data network interface 102 receives the selected data item from the transaction management module 106 and outputs the selected data item to the user. Data item output can be in the form of a displayed picture on an ATM, cell phone, and/or PDA screen, or can be in the form of a synthetic voice generated by the data network interface 102. In step 212, if requested by the user, the transaction management module 106 can authorize and command the data network interface 102 to generate a certificate of authenticity for the user selected data item. Such a certificate would perhaps be in the form of an electronic signature and/or electronic notarization which is acceptable to whomever the data item is presented.

In step 214, the data network interface 102 inputs a new data item from the user. Input may be in the form of keyed or scanned in data. In step 216, transaction management module 106 receives the new data item from the data network interface 102 and stores the new data item in the user's data file within the data file repository 108.

In step 218, the transaction management module 106 generates an invoice corresponding to a data transaction fee associated with the data transaction services thus provided to the user. The data transaction fee may be automatically debited from the user's bank or other account. After step 218, the method ends.

While one or more embodiments of the present invention have been described, those skilled in the art will recognize that various modifications may be made. Variations upon and modifications to these embodiments are provided by the present invention, which is limited only by the following claims.

What is claimed is:

1. A method for data transaction, comprising the steps of:
receiving an Automated Teller Machine (ATM) card from a user at an ATM;
providing secure access to a data file containing data items previously input by the user;
selecting a data item from the data file, in response to a command from the user; and
outputting the selected data item to the user from the ATM.

2. The method of claim 1, wherein the selecting step includes the step of selecting an audible data item.

3. The method of claim 1, wherein the selecting step includes the step of selecting a numerical data item.

4. The method of claim 1, wherein the selecting step includes the step of selecting a textual data item.

5. The method of claim 1, wherein the selecting step includes the step of selecting a pictorial data item.

6. The method of claim 1, wherein the selecting step includes the step of selecting an e-mail.

7. The method of claim 1, wherein the selecting step includes the step of selecting a set of drawings.

8. The method of claim 1, wherein the selecting step includes the step of selecting a photo.

9. The method of claim 1, wherein the selecting step includes the step of selecting an address book.

10. The method of claim 1, wherein the selecting step includes the step of selecting medical information.

11. The method of claim 1 further comprising the steps of:
inputting a new data item from the user; and
storing the new data item in the data file.

12. The method of claim 11, wherein the inputting step includes the step of scanning in the new data item.

13. The method of claim 11, wherein the inputting step includes the step of keying in the new data item.

14. The method of claim 11, wherein the inputting step includes the step of recording the new data item.

15. The method of claim 1, wherein the outputting step includes the step of displaying a visual image of the data item.

16. The method of claim 1, wherein the outputting step includes the step of playing an audible recitation of the data item.

17. The method of claim 1, wherein the outputting step includes the step of printing out the data item.

18. The method of claim 1 further comprising the step of:
outputting a certificate which authenticates the data item.

19. A method for data transaction, comprising the steps of:
receiving a telephone call from a user on a telephone network;
providing secure access to a data file containing data items previously input by the user;
selecting a data item from the data file, in response to a command from the user; and
outputting the selected data item to the user over the telephone network.

20. The method of claim 19, wherein the selecting step includes the step of selecting an audible data item.

21. The method of claim 19, wherein the selecting step includes the step of selecting a numerical data item.

22. The method of claim 19, wherein the selecting step includes the step of selecting a textual data item.

23. The method of claim 19, wherein the selecting step includes the step of selecting a pictorial data item.

24. A method for data transaction, comprising the steps of:
receiving an identification card from a user at a service station fueling pump;
providing secure access to a data file containing data items previously input by the user;
selecting a data item from the data file, in response to a command from the user; and
outputting the selected data item to the user from the fueling pump.

25. A computer-usable medium embodying computer program code for commanding a computer to execute data transactions comprising the steps of:
receiving an Automated Teller Machine (ATM) card from a user at an ATM;
authenticating the ATM card and the user;
providing secure access to a data file containing data items previously input by the user;
selecting a data item from the data file, in response to a command from the user;
outputting the selected data item to the user from the ATM;
outputting a certificate which authenticates the data item;
inputting a new data item from the user; and
storing the new data item in the data file.

26. A system for data transaction comprising a:
means for receiving an Automated Teller Machine (ATM) card from a user at an ATM;
means for providing secure access to a data file containing data items previously input by the user;
means for selecting a data item from the data file, in response to a command from the user; and
means for outputting the selected data item to the user from the ATM.

27. A system for data transaction, comprising:
a data network interface, for receiving an Automated Teller Machine (ATM) card from a user;
an identity authentication module, coupled to the interface, for authenticating the ATM card and the user;
a transaction management module, coupled to the interface, for providing secure access to a data file containing data items previously input by the user; and
a data file repository, coupled to the transaction management module, for storing the data file.

28. A system for data transaction, comprising:
a data network interface, for receiving a telephone call from a user;
an identity authentication module, coupled to the interface, for authenticating the telephone call and the user;
a transaction management module, coupled to the interface, for providing secure access to a data file containing data items previously input by the user; and
a data file repository, coupled to the transaction management module, for storing the data file.
